(19) United States
(12) Patent Application Publication
(10) Pub. No.: US 2026/0343076 A1
(43) Pub. Date: Oct. 29, 2026

(54) DISPLAY DEVICE WITH AN IR CAMERA FOR A VEHICLE

(71) Applicant: BHTC GmbH, Lippstadt (DE)

(72) Inventors: Tuomas SIEKKINEN, Tampere (FI); Hanna KANKKUNEN, Tampere (FI)

(21) Appl. No.: 19/107,809

(22) PCT Filed: Sep. 19, 2023
(86) PCT No.: PCT/EP2023/075779

§ 371 Date: Feb. 28, 2025

(30) Foreign Application Priority Data
Sep. 20, 2022 (DE) 10 2022 124 031.2
Dec. 14, 2022 (DE) 10 2022 133 344.2

(51) Int. Cl. H04N 23/21; B60K 35/10; B60K 35/22; F21V 8/00; G02F 1/1335; G02F 1/13357; H04N 23/56

(52) U.S. Cl. CPC H04N 23/21; B60K 35/10; B60K 35/22; G02B 6/0053; G02F 1/133536; G02F 1/1336; H04N 23/56; B60K 2360/1434

(57) ABSTRACT

The display device (10) with an IR camera for a vehicle is provided with a display (18) having a front side with a display area (24) and a back side, and a backlighting unit (26) having backlighting light sources (38) and having a light guide (28) which comprises a light emission side (30), a back side (32) facing away from the latter and a circumferential edge side (34) connecting the front side to the back side (32), wherein the backlighting light sources (38) radiate visible light into at least a portion of the edge side (34). The intermediate space between the back side of the display (18) and the light emission side (30) of the light guide (28) is free of optical light diffusion elements. The display device (10) is further provided with a reflection film arranged on the back side of the light guide (28) or opposite thereto for reflecting backlighting light (36) and for transmitting IR light, the reflection film having a back side facing away from the light guide (28), and with IR light sources (46) and an IR photodiode array (48), all of which are arranged facing the back side of the reflection film. IR light from the IR light sources (46) passes through the reflection film, the light guide (28), and the display (18) and reaches a region in front of the display area (24), and IR light from the IR light sources (46) reflected at an object potentially located in this region passes through the display (18), the light guide (28) and the reflection film and reaches the IR photodiode array (48).

The invention relates to a display device with an IR camera for a vehicle and, in particular, to a display device in which the IR camera is arranged behind the display area of the display or, in other words, behind that area of the display device which is enclosed by a frame that typically surrounds the display.

To increase vehicle safety, it has long been known to monitor the vehicle interior for possible safety risks. In particular, it is known to detect the driver's face, for example in order to recognize possible driver fatigue at an early stage based on the movement of the driver's eyelids, so that a corresponding alarm signal can then be emitted.

For various reasons, the cameras used for this purpose should be part of the display devices installed in the instrument panel. In principle, the frame that typically surrounds the display device is suitable for accommodating the cameras in such display devices. However, for visual reasons, the trend is increasingly towards making these frames as narrow as possible, so that there is no longer enough space in this area to accommodate the camera. The same applies to the edge region of the display itself, which is typically colored black on the display area.

It is known, for example, to arrange IR cameras behind the display and behind its backlighting unit. An example of such a concept is described in EP-A-3 608 147. However, this known system uses two different stacks of “optical films” for the IR camera on the one hand and the actual display area on the other, which can be undesirable.

A display device with an IR camera for a vehicle is known from US-A-2010/0073584, in which no reflection polarization filter is arranged behind the display for the backlighting light that backlights the display.

In DE-A-10 2009 002 184, a head-up display is known in which a projection unit is provided, the projection light of which passes through a reflection polarization film before reaching the windscreen.

Further display devices are described in DE-A-10 2019 001 333 and DE-A-10 2016 224 246.

The object of the invention is to provide a display device with an IR camera for a vehicle in which the structure and arrangement of the individual optical and opto-electronic and illumination layers are the same both for the region of the display area and for the IR camera.

The object of the invention is achieved with the invention proposing a display device with IR camera for a vehicle, the display device being provided with
an LCD display in particular having a front side with a display area and a back side,
a backlighting unit having backlighting light sources and having a light guide which comprises a light emission side, a back side facing away from the latter and a circumferential edge side connecting the front side to the back side, wherein the backlighting light sources radiate visible light into at least a portion of the edge side,
wherein the intermediate space between the back side of the display and the light emission side of the light guide is free of optical light diffusion elements,
a reflection film arranged on the back side of the light guide or opposite thereto for reflecting backlighting light and for transmitting IR light, wherein the reflection film has a back side facing away from the light guide,
IR light sources and an IR photodiode array, all of which are arranged facing the back side of the reflection film, and
a first specular reflection polarization film arranged on the back side of the display or opposite thereto for reflecting visible backlighting light, the polarization of which deviates from the polarization direction of the back-side polarization filter of the display, wherein backlighting light reflected by the specular reflection polarization film can be reflected back from the reflection film towards the specular reflection polarization film while changing its polarization direction,
wherein IR light from the IR light sources passes through the reflection film, the light guide, the first specular reflection polarization film and the display and thus reaches a region in front of the display area, and IR light from the IR light sources reflected at an object potentially located in this region passes through the display, the first specular reflection polarization film, the light guide and the reflection film and thus reaches the IR photodiode array.

The display device according to the invention, which can also have an operating function if required, has a display typically designed in LCD technology, which has a front side with a display area and a back side. Behind the display is the backlighting unit with a light guide that has a light emission side, a back side facing away therefrom and a circumferential edge side connecting the front side to the back side. The backlighting light sources of the backlighting unit feed their visible backlighting light into the edge of the light guide (edge lit). The light guide itself is typically configured as a plate or thin film. There are no optical light diffuser elements in the intermediate space between the back side of the display and the light emission side of the light guide.

Facing the back side of the light guide is a reflection film for reflecting backlighting light and for transmitting IR radiation (hereinafter also referred to as IR light), wherein this IR-transmitting reflection film can also be part of the back side of the light guide. The reflection film has a back side facing away from the light guide. An example of a material that is transparent to IR radiation and otherwise reflective to (visible) light is described in U.S. Pat. No. 5,233,465 A, for example.

IR radiation sources (hereinafter also referred to as IR light sources) and an IR photodiode array (as an IR camera) are located on the back side of this IR-permeable reflection film. The IR light from the IR light sources passes through the reflection film, the light guide and the display and thus reaches a region in front of the display area. There it is reflected by an object such as a hand or a person (driver observation) and thus passes through the display, the light guide and the IR-transparent reflection film to the IR photodiode array.

According to a further feature of the invention, the display device comprises a first specular reflection polarization film arranged on the back side of the display or opposite thereto for reflecting visible backlighting light, the polarization of which deviates from the polarization direction of the back-side polarization filter of the display, wherein backlighting light reflected by the specular reflection polarization film can be reflected back from the reflection film towards the specular reflection polarization film while changing its polarization direction. This (first) specular reflection polarization film reflects backlighting light, the polarization direction of which does not match the direction specified by the back-side polarization filter for the display. Such backlighting light is therefore reflected and reaches the IR-transparent reflection film, where it is reflected back again while changing its polarization direction. This means that light that would otherwise be absorbed by the back-side polarization filter can be used to backlight the display. A specular reflection polarization film that can be used in the context of this and the further embodiments of the invention described below is offered by the US company 3M under 3M APF (3m-automotive-reflective-polarizer-3m-arp-320-tech-data-sheet.pdf).

The concept of the display device according to the invention has the advantage that no space is required in the frame or edge region of the display device for accommodating the IR camera, so the size of the display area can be maximized, wherein the backlighting light intensity of the display is impaired, although the entire display device, i.e. the display and the backlighting unit, must be transparent to IR light.

A thin light guide film with a prismatic structure of minimum size is particularly suitable as a light guide for the backlighting unit. Such light guide films are distributed by the Finnish company Nanocomp Oy, for example (https://www.nanocomp.fi/wp-content/uploads/2022/04/nanocomp_directional_light_guide_film_lowres_4-2022. pdf).

However, it is also possible for such a light guide film to be arranged on a conventional light guide, the light emission side of which has no structure at all, by optical bonding.

This light guide film ensures optimum homogenization of the backlighting light without the need for additional light diffusion elements, which are typically arranged between the backlighting unit and the display.

In a further advantageous embodiment of the invention, the specular polarization film also reflects IR light, the polarization of which deviates from the polarization direction of the back-side polarization filter of the display, wherein an IR reflection film is arranged below the IR light sources for reflecting IR light reflected by the first specular reflection polarization film while changing the polarization direction. In this way, the specular reflection polarization film can also be used to increase the use of IR light.

It may be expedient if a second specular reflection polarization film is arranged on the back side of the IR-transparent reflection film or opposite thereto for reflecting IR light, the polarization of which deviates from the polarization direction of the back-side polarization filter of the display, wherein an IR reflection film is arranged below the IR light sources for reflecting IR light reflected by the second specular reflection polarization film while changing the polarization direction. In this exemplary embodiment, the second specular reflection polarization film therefore serves to improve the IR luminous efficiency.

Typically, the IR light sources emit NIR light, wherein the IR photodiode array is accordingly an NIR photodiode array. The photodiode array can basically be one-or two-dimensional.

As already explained above, the display area of the display can also be used for entering commands by touching the display area if a touch sensor system is integrated accordingly, as can be realized by a touch panel, for example.

Finally, an optical lens for IR radiation can be arranged between the IR-transparent reflection film and the IR photodiode array.

According to an advantageous configuration of the invention, it can be provided that a diffuser layer for scattering the backlighting light is located in the intermediate space between the light emission side of the light guide and the back side of the display, which allows the IR light from the IR light sources to pass through without scattering. According to a further advantageous embodiment of the invention, it may be provided that the diffuser layer, which is neutral to IR light, is arranged between the light guide and the specular reflection polarization film or between the specular reflection polarization film and the display. The advantage of the diffuser layer, which is neutral to IR light, is that although the backlighting light is scattered, the IR light is not scattered. The latter is particularly advantageous for IR light recording by the IR camera.

The invention is thus characterized by the special features of the backlighting light unit, which ensures that the display is backlit sufficiently brightly and thus with the required light intensity and homogeneity, while at the same time IR light reaches the camera through the display without this light leading to an unsharp, blurred image. Rather, the IR image is sufficiently sharp to be able to extract the necessary information from the IR image by editing or processing.

Just as an edge-lit concept is used for backlighting the display with visible light, this can also be the case for feeding in IR light. Behind the IR-transparent reflection film there is a light guide with IR light at the side, which deflects the IR light and projects it onto the IR-transparent reflection film from behind.

To ensure that the IR light can reach the IR photodiode array as scattered light, for example, it is expedient to optically seal off the IR photodiode array from the IR light sources or the IR light guide described above.

In the variant of the invention described so far, there is no light-scattering diffuser in the intermediate space between the light emission side of the light guide and the back side of the display. However, such a diffuser would be advantageous if it only scatters the backlighting light. In the state of the art, diffuser films are known which scatter the light or allow it to pass through without scattering, depending on the wavelength of the light. In this context, please refer to https://onlinelibrary.wiley.com/doi/full/10.1002/adma.202105868.

It is now advantageous if such a light wavelength-dependent diffuser is arranged in the intermediate space between the light emission side of the light guide and the back side of the display, which scatters the backlighting light and allows the IR light from the IR light sources to pass through without scattering. This diffuser, which is “neutral” to IR light in this respect, can be arranged between the specular reflection polarization film, if present, and either the display or the light guide.

The invention is described in more detail below with reference to an exemplary embodiment for the above-described first variant of the invention and with reference to the drawing. In detail, the Figures show:

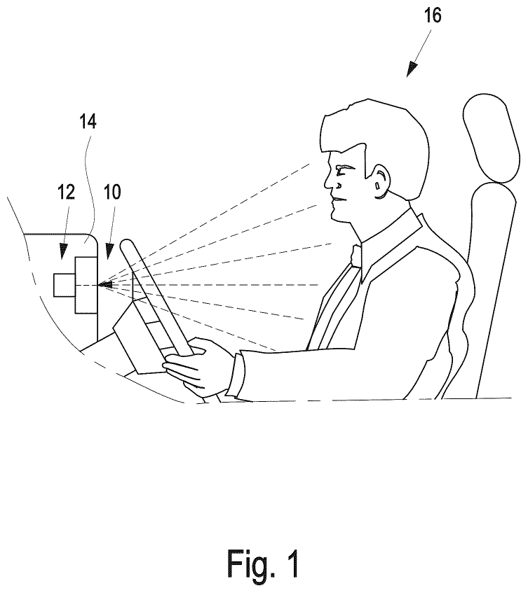

FIG. 1 shows an example of the application of the display device according to an exemplary embodiment of the invention,

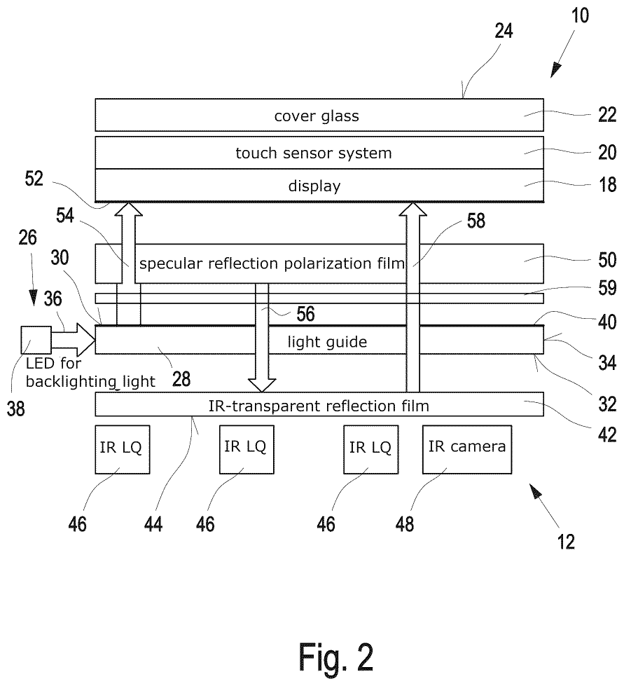

FIG. 2 shows a first example of the optical layer stack of the display device (highly schematized), and

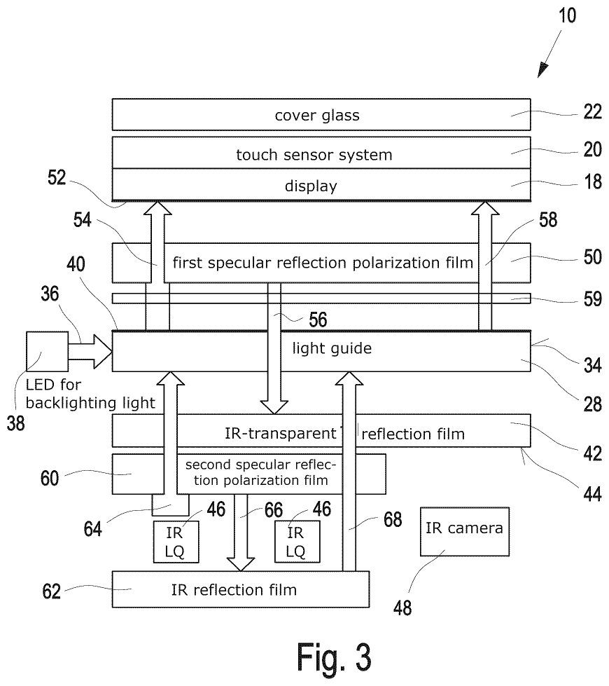

FIG. 3 shows a second example of the optical layer stack of the display device (highly schematized).

FIG. 1 shows an application example for the display device 10 according to the invention with an IR camera 12 arranged behind it. In this exemplary embodiment, both are arranged in the instrument panel 14 of a vehicle, with the IR camera 12 directed towards the driver 16. The information extracted from the camera image is application-specific and known in principle, which is why it does not need to be discussed in detail in the context of the present invention.

FIG. 2 shows a highly schematized first exemplary embodiment of the individual optical and opto-electronic layers of the display device 10, wherein neither the thickness of the individual layers nor their spacing is to scale.

In the exemplary embodiment of FIG. 2, the display device 10 comprises, for example, an LCD display 18 with a touch sensor system 20, which are arranged behind a cover glass 22. In this exemplary embodiment, the display device 10 is therefore also used to enter commands by touching the display area 24.

Behind the display 18 there is a backlighting unit 26 for backlighting the display 18 with visible light. For this purpose, the backlighting unit 26 has a light guide 28, which has a light emission side 30 facing the display 18 and a back side 32 facing away therefrom. Both sides or main surfaces of the light guide 28 are connected to each other by a circumferential edge side 34. The backlighting light 36 is radiated into a portion of this edge side 34, which is realized with several backlighting light sources 38 in the form of LEDs, for example. There is an additional light guide film 40 on the light emission side 30, which has a light prism structure of minimum size. This light guide film 40 is offered by the Finnish company Nanocomp Oy, for example.

According to the invention, there are no light diffuser films or similar elements between the backlighting unit 26 and the display 18, since such elements would be detrimental to the IR light, which will be discussed further below.

Below the light guide 28, namely facing its back side 32, there is an IR-transparent reflection film 42, which also belongs to the backlighting unit 26. This reflection film ensures that backlighting light is reflected towards the display 18.

Facing the back side 44 of the IR-transparent reflection film 42 are IR light sources 46 in the form of LEDs, for example. Furthermore, the IR camera 12, for example in the form of an IR photodiode array 48, is also located facing the back side 44 of the IR-transparent reflection film 42.

It is also optional, but advantageous, to provide a diffuser layer 59, which is neutral to IR light, between the light guide 28 and the (first) specular reflection polarization film 50 or between the latter and the display 18, which scatters the backlighting light but allows the IR light to pass through without scattering. This homogenizes the backlighting of the display 18 without scattering either the IR light reaching the region in front of the display 18 or in front of its cover glass 22 or the IR light potentially reflected therefrom, which is advantageous with regard to IR recording by the IR camera 48.

A (first) specular reflection polarization film 50 is located between the backlighting unit 26 and the back side of the display 18, which reflects backlighting light with a polarization direction that deviates from the polarization direction specified by the back-side polarization film 52 (for reasons of clarity, the front-side polarization film of the display 18 is not illustrated) of the display 18, in the direction of the IR-transparent reflection film 42, where the backlighting light is reflected back again while changing its polarization direction. This is indicated by arrows 54, 56 and 58. This measure ensures that almost the entire proportion of backlighting light from the backlighting light sources 38 can also be used for backlighting the display 18.

The (first) specular reflection polarization film 50 can also be used to reflect back the IR light from the IR light sources 46, the polarization direction of which deviates from the direction specified by the back-side polarization film 52 of the display. However, this still requires a reflection film for IR light, which is not yet shown in FIG. 2.

Alternatively, however, laser diodes can also be used as IR light sources, which emit light exclusively with a polarization direction corresponding to that of the back-side polarization film 52 of the display 18.

In the exemplary embodiment of the “optical stack” of FIG. 2, the light guide film 40 and the (first) specular reflection polarization film 50 are optional; both layers could therefore also be omitted.

The light from the IR light sources 46 passes through the backlighting unit 26 and further through the display, the touch sensor system and the cover glass into the region in front of the display device 10, where it is reflected by objects potentially located there that are to be monitored or detected, in order to ultimately be recorded as a reflection image by the IR camera 12.

It is also optional, but advantageous, to provide a diffuser layer 59, which is neutral to IR light, between the light guide 28 and the (first) specular reflection polarization film 50 or between the latter and the display 18, which scatters the backlighting light but allows the IR light to pass through without scattering. This homogenizes the backlighting of the display 18 without scattering either the IR light reaching the region in front of the display 18 or in front of its cover glass 22 or the IR light potentially reflected therefrom, which is advantageous with regard to IR recording by the IR camera 48.

In FIG. 3, the previously mentioned case is shown graphically, in which the optical stack of the display device 10 has layers that ensure the reflection of IR light that has a polarization direction that deviates from the direction specified by the back-side polarization film 52 of the display 18, namely in order to increase the IR luminous efficiency. Those layers and elements of FIG. 3 that are identical to those in FIG. 2 are provided with the same reference numerals in FIG. 3 as in FIG. 2.

The light from the IR light sources 46 is reflected at a second specular reflection polarization film 60 if the polarization direction does not match the back-side polarization film 52 and reaches an IR reflection film 62, which is arranged below the IR light sources 46, for example. IR light reflected from there, while changing its polarization direction, passes back towards the second specular reflection polarization film 60 and, if the polarization direction is correct, passes therethrough (the above is indicated in FIG. 3 by arrows 64, 66 and 68) and into the region in front of the display device 10, where it is reflected back by an object to be observed or detected in order to be recorded by the IR camera 12.

### LIST OF REFERENCE NUMERALS

10 display device
12 IR camera
14 instrument panel
16 driver
18 display
20 touch sensor system
22 cover glass
24 display area
26 backlighting unit
28 light guide
30 light emission side
32 back side of light guide
34 edge side of light guide
36 backlighting light
38 backlighting light source
40 light guide
42 IR-transparent reflection film
44 back side of IR-transparent reflection film
46 IR light sources
48 IR photodiode array
50 first specular reflection polarization film
52 back-side polarization film of display
54 arrow
56 arrow
58 arrow
59 diffuser layer for backlighting light neutral to IR light
60 second specular reflection polarization film
62 IR reflection film
64 arrow
66 arrow
68 arrow

1. A display device with an IR camera for a vehicle, comprising
a display having a front side with a display area and a back side,
a backlighting unit having backlighting light sources and having a light guide which comprises a light emission side, a back side facing away from the latter and a circumferential edge side connecting the front side to the back side, wherein the backlighting light sources radiate visible light into at least a portion of the edge side,
wherein the intermediate space between the back side of the display and the light emission side of the light guide is free of optical light diffusion elements,
a reflection film arranged on the back side of the light guide or opposite thereto for reflecting backlighting light and for transmitting IR light, wherein the reflection film has a back side facing away from the light guide,
IR light sources and an IR photodiode array, all of which are arranged facing the back side of the reflection film, and
a first specular reflection polarization film arranged on the back side of the display or opposite thereto for reflecting visible backlighting light, the polarization of which deviates from the polarization direction of the back-side polarization filter of the display, wherein backlighting light reflected by the specular reflection polarization film can be reflected back from the reflection film towards the specular reflection polarization film while changing its polarization direction,
wherein IR light from the IR light sources passes through the reflection film, the light guide, the first specular reflection polarization film and the display and thus reaches a region in front of the display area, and IR light from the IR light sources reflected at an object potentially located in this region passes through the display the first specular reflection polarization film, the light guide and the reflection film and thus reaches the IR photodiode array.

2. The display device according to claim 1, wherein the light guide is configured as a light guide film.

3. The display device according to claim 1, wherein the light guide has a light guide film and a light guide plate which are bonded together by an optical adhesive layer.

4. The display device according to claim 1, wherein the first specular reflection polarization film also reflects IR light, the polarization of which deviates from the polarization direction of the back-side polarization filter of the display, and wherein an IR reflection film is arranged specular the IR light sources for reflecting IR light reflected by the first specular reflection polarization film while changing the polarization direction.

5. The display device according to claim 1, characterized by a second specular reflection polarization film arranged on the back side of the reflection film or opposite thereto for reflecting IR light, the polarization of which deviates from the polarization direction of the back-side polarization filter of the display, and an IR reflection film arranged below the IR light sources for reflecting IR light reflected by the second specular reflection polarization film while changing the polarization direction.

6. The display device according to claim 1, wherein the IR light sources emit NIR light and that the IR photodiode array is an NIR photodiode array.

7. The display device according to claim 1, wherein the IR photodiode array is two-dimensional.

8. The display device according to claim 1, characterized by a touch panel for manual input of commands by touching the display area of the display.

9. The display device according to claim 1, characterized by at least one optical lens arranged between the reflection film and the IR photodiode array.

10. The display device according to claim 1, wherein a diffuser layer for scattering the backlighting light is located in the intermediate space between the light emission side of the light guide and the back side of the display, which allows the IR light from the IR light sources to pass through without scattering.

11. The display device according to claim 10, wherein the diffuser layer, which is neutral to IR light, is arranged between the light guide and the specular reflection polarization film or between the specular reflection polarization film and the display.
